(19) United States
(12) Patent Application Publication
(10) Pub. No.: US 2010/0268461 A1
(43) Pub. Date: Oct. 21, 2010

(54) NAVIGATION APPARATUS, DATA PROCESSING APPARATUS, AND GEOGRAPHIC MAP DATA APPLICATION METHOD

(75) Inventor: RONG-TARNG YU, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MITAC INTERNATIONAL CORP., Guishan Shiang (TW)

(21) Appl. No.: 12/760,671

(22) Filed: Apr. 15, 2010

(30) Foreign Application Priority Data
Apr. 17, 2009 (TW) 098112843

(51) Int. Cl. G01C 21/36; G08G 1/09

(52) U.S. Cl. 701/210; 701/209; 701/200

(57) ABSTRACT

The invention provides a navigation apparatus, a data processing apparatus, and a geographic map data application method. The navigation apparatus receives positioning information. The navigation apparatus sends a route request to a data processing apparatus. The navigation apparatus receives a first route and a geographic map data corresponding to the route request from the data processing apparatus. Wherein, the geographic map data includes the first route and regions near the first route.

### CROSS-REFERENCE TO RELATED APPLICATION

This utility application claims priority to Taiwan Application Serial Number 098112843, filed Apr. 17, 2009, which is incorporated herein by reference.

### BACKGROUND OF THE INVENTION

1. Field of the Invention

The present invention relates to satellite positioning navigation, and more particularly, to a navigation apparatus, a data processing apparatus, and a geographic map data application method for downloading the map data and related information according to personal needs.

2. Description of the Prior Art

In recent years, with the development and innovation of the communication technology, various kinds of portable electronic apparatuses, such as a mobile phone, a PDA, and a satellite positioning navigation apparatus, have become a necessary tool in our daily life. Especially, the satellite positioning navigation apparatus with the functions of driving navigation and route planning is very popular for ordinary consumers.

In general, the ordinary satellite positioning navigation apparatus mostly receives the current position information and the current time information related to the satellite positioning navigation apparatus via a satellite positioning system. And, the most common satellite positioning systems in the world include a global positioning system (GPS), an assisted global positioning system (AGPS), and so on.

Since the wireless network technology and the wire network technology both develop very rapidly, therefore, the broadband network has gradually become popular and the broadband wireless communication network could be provided (e.g., the 3G network such as the HSUPA network). Further, the internet media applications needing more internet bandwidth, such as the famous media sharing website YouTube, will be developed and become popular rapidly. However, the media contents of the current media sharing websites are the films, images, or music files uploaded by the users at first, and then these files will be stored in the data center of the web platform providers. Therefore, it is necessary for other users to perform a search on the websites to obtain the media data they needed.

In other words, the users can only find out the data they needed from the currently stored data in the websites, and the users fail to obtain the real-time data (the most updating data). Taking the map website for example, the contents of the store information, street information, or image information provided by the map website are provided by the map data provider or uploaded by other users. If the map website does not provide any needed data, the user can only passively wait for the map data provider to update data.

In addition, the method of preloading all maps is mostly used in current navigation apparatuses, after the user selects the starting point and the destination, the navigation apparatus will calculate the minimum distance route or the minimum driving time route according to its default route algorithm. However, since the route algorithm is default, therefore, the same planned route will be obtained if the starting point and the destination are the same. Moreover, the current route algorithm fails to take the best travel route or the travel route suitable for different numbers of travelers (e.g., a traveler alone or four travelers of a family) into consideration.

Therefore, the main scope of the invention is to provide a navigation apparatus, a data processing apparatus, and a geographic map data application method to solve the above-mentioned problems.

### SUMMARY OF THE INVENTION

A scope of the invention is to provide a data processing apparatus. In an embodiment of the invention, the data processing apparatus is coupled to a navigation apparatus. When the data processing apparatus receives a route request sent by the navigation apparatus, the data processing apparatus responds the route request and sends a first route and a geographic map data corresponding to the route request to the navigation apparatus, wherein the geographic map data includes the first route and regions near the first route.

Another scope of the invention is to provide a geographic map data application method. In an embodiment of the invention, the geographic map data application method is applicable to a navigation apparatus. The geographic map data application method includes the following steps. Firstly, the navigation apparatus receives positioning information; next, the navigation apparatus sends a route request to a data processing apparatus; then, the navigation apparatus receives a first route and a geographic map data corresponding to the route request from the data processing apparatus. Wherein, the geographic map data includes the first route and regions near the first route.

Compared to the prior arts, since the conventional way of preloading all maps in portable navigation device is not used by the navigation apparatus of the invention, not only different planned routes could be obtained by downloading the map data and related information according to personal needs, but also the navigating routes originally planned could be revised based on real time traffic information to avoid the condition that the travel route is affected by the accidents such as traffic jam or car accident. Additionally, the navigation apparatus of the invention could also upload the route information that the driver actually drives to the data processing apparatus, so that it could be a reference for other drivers to plan travel routes in the future.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a functional block diagram of the navigation apparatus in the first embodiment of the invention.

FIG. 2 illustrates a scheme diagram of an example of the display screen of the navigation apparatus.

FIG. 3 illustrates a flowchart of the geographic map data application method in the second embodiment of the invention.

### DETAILED DESCRIPTION OF THE INVENTION

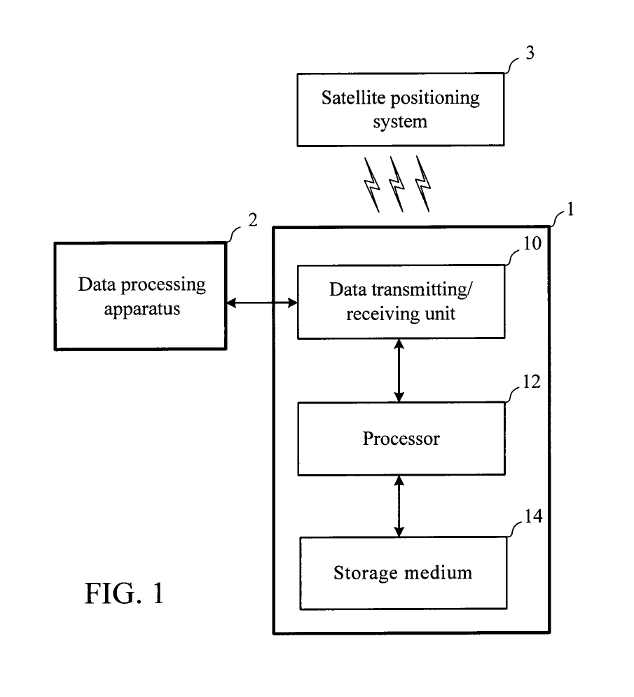

A first embodiment of the invention is a navigation apparatus. In fact, the navigation apparatus could be any portable electronic apparatus capable of receiving a satellite positioning signal or having a satellite positioning function (e.g., a mobile phone having the satellite positioning function or a GPS satellite positioning navigation apparatus) to be used to plan the route for travel, but not limited by this case. Please refer to FIG. 1. FIG. 1 illustrates a functional block diagram of the navigation apparatus.

As shown in FIG. 1, the navigation apparatus 1 is coupled to a data processing apparatus 2. In fact, the data processing apparatus 2 could be a location-aware service (LAS) server, but not limited by this case. The navigation apparatus 1 includes a data transmitting/receiving unit 10, a processor 12, and a storage medium 14. Wherein, the data transmitting/receiving unit 10 and the storage medium 14 are coupled to the processor 12 respectively. In practical applications, the navigation apparatus 1 includes an antenna used for sending a route request signal to a satellite positioning system 3 and receiving a satellite positioning signal from the satellite positioning system 3. Next, the units of the navigation apparatus 1 and their functions will be described in detail as follows.

In this embodiment, the navigation apparatus 1 receives positioning information from the satellite positioning system 3 via the data transmitting/receiving unit 10. If the navigation apparatus 1 is installed in car, the positioning information will show the current latitude and longitude coordinates of car, and current time may come from car's clock.

In fact, the satellite positioning system 3 could be one of the most well-known satellite positioning systems, such as GPS, AGPS, global navigation satellite system (GLONASS), or Galileo satellite navigation positioning system, but not limited by these cases.

In this embodiment, the user can input his/her personal travel plan and related information into the navigation apparatus 1 in advance, such as the information about the predetermined starting point and departure time, and the predetermined destination and arrival time; he/she plans to drive the car on an ordinary road, a highway, or an elevated expressway; he/she wants to buy something to eat at a rest stop or go to a restaurant to have lunch. The personal information could be transmitted or inputted into the navigation apparatus 1 in a packaged information/message form and stored in the storage medium 14 of the navigation apparatus 1, so that it could be used as an important reference for the navigation apparatus 1 to plan the route for travel afterward, since such personal information is not that large, the transmission time will be very short, for making thing effective, such personal information could be in specific format, so that the data processing apparatus could promptly apply such personal information in following calculation or application to form a first route.

The personal information may include the users age, such as there are kids or babies, it will assist the route calculation, to include the stores selling kids and/or babies goods during the travel, and may need more stops for toilet, or at least taking into consideration for such information.

After the user inputted the planned personal information into the navigation apparatus 1, if the user is ready to start off, the only thing the user needs to do is to touch the route planning key shown on the touch monitor of the navigation apparatus 1, then the navigation apparatus 1 will generate a route request according to the personal information inputted by the user in advance, and send the route request to the data processing apparatus 2 via the data transmitting/receiving unit 10. The route request includes a starting point of a route, a destination point of a route, a scenic spot, and a route range, namely, a specific section of a road or a specific area such as a specific road segments which surround a mall user would like to travel.

After the data processing apparatus 2 receives the route request, the data processing apparatus 2 will respond the route request and send the first route corresponding to the route request and a geographic map data including the first route to the navigation apparatus 1. In comparison with the way of preloading all maps in portable navigation device in prior arts, it should be noticed that the navigation apparatus 1 in present invention will not preload all maps inside; instead, the navigation apparatus 1 will only download the related map information corresponding to the route request from the data processing apparatus 2, so that the downloading time and the storage space could be largely reduced.

In practical applications, the related geographic map data covers only administrative regions passing by the first route, or covers a specific area along the first route. That is to say, the geographic map data downloaded by the navigation apparatus 1 is not the entire geographic map data; the navigation apparatus 1 only downloads the map information near the first route, but not limited by these cases.

Except the above-mentioned first route and the geographic map data related to the first route, the navigation apparatus 1 could also download a point of interest (POI) information near the first route from the data processing apparatus 2. For example, the POI information could include local store information, local scenic spot information, or local activity information, but not limited by these cases.

Then, after the navigation apparatus 1 has already obtained the positioning information from the satellite positioning system 3 via the data transmitting/receiving unit 10 and downloaded the first route and the geographic map data from the data processing apparatus 2, the processor 12 of the navigation apparatus 1 could revise the first route according to the geographic map data and the positioning information, so that the revised first route could be a reference for the driver to drive the car.

In practical applications, the navigation apparatus 1 could receive a traffic information from a traffic message channel (TMC) via the data transmitting/receiving unit 10, and then the processor 12 of the navigation apparatus 1 could selectively change the planned first route according to the traffic information, so that the driver could avoid the traffic jam or car accident to prevent the delay of his/her schedule.

It should be noticed that during the period that the user drives the car, the processor 12 of the navigation apparatus 1 will continually record the positioning information about the car, as car moving, these continually recorded positioning information will form a second route. If the user drives the car totally the same as the route planned by the processor 12 of the navigation apparatus 1, the second route will be the same as the first route; on the contrary, the second route will be different from the first route.

In this embodiment, the second route could be stored in the storage medium 14 of the navigation apparatus 1, or uploaded to the data processing apparatus 2 via the data transmitting/receiving unit 10, so that the second route could be used as a reference for future travel route planning or other drivers. Moreover, the various routes uploaded by different drivers could be further statistically analyzed in detail.

In addition, when the processor 12 of the navigation apparatus 1 records the positioning information of the car, the navigation apparatus 1 could receive auxiliary information related to the positioning information. In fact, the auxiliary information could include at least one image or at least one character. For example, the auxiliary information could be pictures taken by the user or texts written by the user at different places in the route. Then, the navigation apparatus 1 could send the auxiliary information and the second route to the data processing apparatus 2 via the data transmitting/receiving unit 10. By doing so, the auxiliary information could enrich the original second route information and record the detail of the journey for the user, so that it will become precious memories in the future.

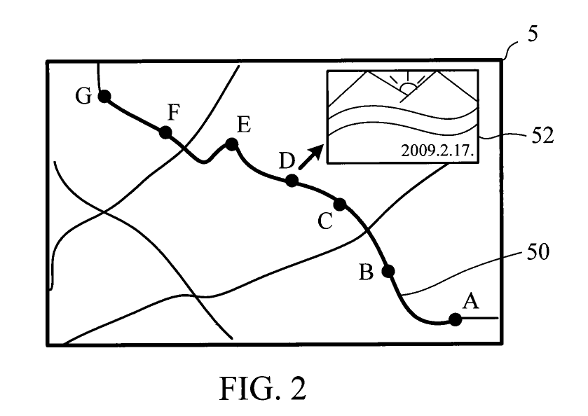

For example, please refer to FIG. 2. FIG. 2 illustrates a scheme diagram of an example of the display screen of the navigation apparatus 1. As shown in FIG. 2, in the display screen 5 of the navigation apparatus 1, the revised first route 50 includes a starting point A, a destination G, and other places B˜F. If the user takes a scenery picture 52 at place D, the scenery picture 52 could be not only shown on the display screen 5, but also uploaded to the data processing apparatus 2 via the data transmitting/receiving unit 10 of the navigation apparatus 1.

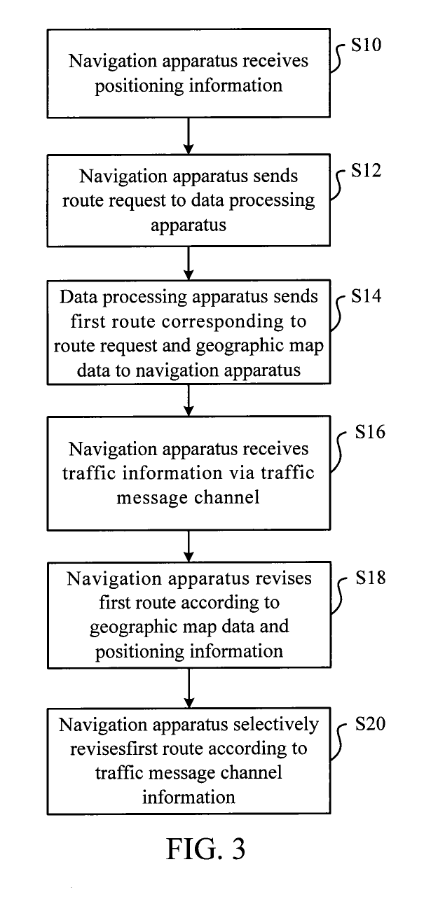

The second embodiment of the invention is a geographic map data application method. In an embodiment of the invention, the geographic map data application method is applicable to a navigation apparatus. The navigation apparatus could be any portable electronic apparatus capable of receiving a satellite positioning signal (e.g., a mobile phone having the satellite positioning function or a GPS satellite positioning navigation apparatus) to plan a route for travel. Please refer to FIG. 3. FIG. 3 illustrates a flowchart of the geographic map data application method.

As shown in FIG. 3, at first, the navigation apparatus receives positioning information (step S10). If the navigation apparatus is installed in car, the positioning information will show the current latitude and longitude coordinates of the car, and current time may come from car's clock. Next, the navigation apparatus sends a route request to the data processing apparatus (step S12). The route request includes a starting point of a route, a destination point of a route, a scenic spot, and a route range, namely, a specific section of a road or a specific area such as a specific road segments which surround a mall user would like to travel.

Then, the data processing apparatus sends the first route and the geographic map data corresponding to the route request to the navigation apparatus (step S14). In comparison with the way of preloading all maps in portable navigation device in prior arts, it should be noticed that the navigation apparatus in present invention will not preload all maps inside; instead, the navigation apparatus will only download the related map information corresponding to the route request from the data processing apparatus, so that the downloading time and the storage space could be largely reduced.

The related geographic map data cover only administrative regions passing by the first route, or covers a specific area along the first route. That is to say, the geographic map data downloaded by the navigation apparatus is not the entire geographic map data; the navigation apparatus only downloads the map information near the first route. More specific, the area defined by distance, by way of circle centers along the first route, and the distance from the center to a radius of one kilometer, it defines the map data it needs to download to assist user's travel.

Except the above-mentioned first route and the geographic map data related to the first route, in this method, the navigation apparatus could also download a point of interest (POI) information near the first route from the data processing apparatus. For example, the POI information includes at least one of local store information, local scenic spot information and local activity information.

Then, the navigation apparatus receives traffic information via a traffic message channel (step S16), for example, the traffic message channel information could be traffic jam, car accident or snowy weather on a specific road section broadcasted from a traffic information radio station. The navigation apparatus thereafter revises the first route according to the geographic map data and the positioning information (step S18) as reference for the driver to drive the car and most important, said traffic message channel data. Then, the navigation apparatus selectively revises the first route according to the traffic message channel information (step S20), so that the driver could avoid the traffic jam or car accident to prevent the delay of his/her schedule.

It should be noticed that during the period that the user drives the car, the navigation apparatus will continually record the positioning information about the car, as car moving, these continually recorded positioning information will form a second route. If the user drives the car totally the same as the route planned by the navigation apparatus, the second route will be the same as the first route; on the contrary, the second route will be different from the first route.

In this embodiment, the second route stored in the navigation apparatus, or uploaded to the data processing apparatus, so that the second route could be a reference for future travel route planning or for the other drivers. Moreover, the various routes uploaded by different drivers could be further statistically analyzed in detail.

In addition, in this method, when the navigation apparatus records the positioning information of the car, the navigation apparatus could receive auxiliary information related to the positioning information. In fact, the auxiliary information includes at least one image or at least one character. For example, the auxiliary information could be pictures taken by the user or texts written by the user at different places in the route. Then, in this method, the navigation apparatus could send the auxiliary information and the second route to the data processing apparatus to record the detail of the journey for the user.

A third embodiment of the invention is a data processing apparatus. In this embodiment, the data processing apparatus is coupled to a navigation apparatus. In fact, the navigation apparatus could be any portable electronic apparatus capable of receiving a satellite positioning signal or having a satellite positioning function (e.g., a mobile phone having the satellite positioning function or a GPS satellite positioning navigation apparatus) to be used to plan the route for travel, but not limited by this case.

In this embodiment, when the data processing apparatus receives a route request sent by the navigation apparatus, the data processing apparatus will respond the route request and send a first route and a geographic map data corresponding to the route request to the navigation apparatus, wherein the geographic map data relates to the first route. The navigation apparatus will receive positioning information from a satellite positioning system and revise the first route according to the geographic map data obtained from the data processing apparatus and the positioning information obtained from the satellite positioning system.

In practical applications, the related geographic map data cover only administrative regions passing by the first route, or covers a specific area along the first route. The route request includes a starting point of a route, a destination point of a route, a scenic spot, and a route range, namely, a specific section of a road or a specific area such as a specific road segments which surround a mall user would like to travel. In addition, the navigation apparatus could also download a point of interest (POI) information near the first route from the data processing apparatus. The POI information includes at least one of local store information, local scenic spot information, and local activity information, but not limited by these cases.

It should be noticed that during the period that the user drives the car, the navigation apparatus will continually record the positioning information about the car, with the car moving, these continually recorded positioning information will form a second route. In fact, the navigation apparatus could store the second route or send the second route to the data processing apparatus. Moreover, when the navigation apparatus records the positioning information of the car, the navigation apparatus could receive auxiliary information related to the positioning information. In fact, the auxiliary information could include at least one image or at least one character, but not limited by these cases. As to the detail description and embodiments of the data processing apparatus and the navigation apparatus could be referred to the above-mentioned first embodiment, it will not be described again here.

Compared to the prior arts, since the conventional way of preloading all maps in portable navigation device is not used by the navigation apparatus of the invention, not only different planned routes could be obtained by downloading the map data and related information according to personal needs, but also the navigating routes originally planned could be adjusted based on real time traffic information to avoid the condition that the travel route is affected by the accidents such as traffic jam or car accident. Additionally, the navigation apparatus of the invention could also upload the route information that the driver actually drives to the data processing apparatus, so that it could be a reference for other drivers to plan travel routes in the future.

Although the present invention has been illustrated and described with reference to the preferred embodiment thereof, it should be understood that it is in no way limited to the details of such embodiment but is capable of numerous modifications within the scope of the appended claims.

What is claimed is:

1. A geographic map data application method, applicable to a navigation apparatus, comprising the steps of:
the navigation apparatus receiving positioning information;
the navigation apparatus sending a route request to a data processing apparatus; and
the navigation apparatus receiving a first route and a geographic map data corresponding to the route request from the data processing apparatus;
wherein the geographic map data includes the first route and regions near the first route.

2. The geographic map data application method of claim 1, further comprising the step of:
the navigation apparatus receiving point of interest (POI) information near the first route from the data processing apparatus.

3. The geographic map data application method of claim 2, wherein the POI information comprises local store information, local scenic spot information, or local activity information.

4. The geographic map data application method of claim 1, wherein the route request comprises a starting point of a route, a destination point of a route, a scenic spot, and a route range.

5. The geographic map data application method of claim 1, further comprising the step of:
the navigation apparatus revising the first route according to the geographic map data and the positioning information.

6. The geographic map data application method of claim 1, further comprising the steps of:
the navigation apparatus receiving traffic information via a traffic message channel (TMC); and
the navigation apparatus selectively revising the first route according to the traffic information.

7. The geographic map data application method of claim 1, further comprising the step of:
the navigation apparatus continually recording the positioning information to form a second route.

8. The geographic map data application method of claim 7, wherein after the step of forming the second route is performed, the navigation apparatus stores the second route.

9. The geographic map data application method of claim 7, wherein after the step of forming the second route is performed, the navigation apparatus sends the second route to the data processing apparatus.

10. The geographic map data application method of claim 7, wherein in the step of recording the positioning information, the navigation apparatus receives auxiliary information related to the positioning information, after the step of forming the second route is performed, the navigation apparatus sends the auxiliary information and the second route to the data processing apparatus.

11. The geographic map data application method of claim 10, wherein the auxiliary information comprises at least one image or at least one character.

12. The geographic map data application method of claim 1, wherein the geographic map data is defined by distance, by way of circle centers along the first route, and the distance from the center to a specific radius.

13. A data processing apparatus, coupled to a navigation apparatus, when the data processing apparatus receives a route request sent by the navigation apparatus, the data processing apparatus responding the route request and sending a first route and a geographic map data corresponding to the route request to the navigation apparatus, wherein the geographic map data includes the first route and regions near the first route.

14. The data processing apparatus of claim 13, wherein the navigation apparatus further receives point of interest (POI) information near the first route from the data processing apparatus.

15. The data processing apparatus of claim 14, wherein the POI information comprises local store information, local scenic spot information, or local activity information.

16. The data processing apparatus of claim 13, wherein the route request comprises a starting point of a route, a destination point of a route, a scenic spot, and a route range.

17. The data processing apparatus of claim 13, wherein the navigation apparatus receives positioning information and revises the first route according to the geographic map data and the positioning information.

18. The data processing apparatus of claim 17, wherein the navigation apparatus continually records the positioning information to form a second route.

19. The data processing apparatus of claim 18, wherein when the navigation apparatus records the positioning information, the navigation apparatus receives auxiliary information related to the positioning information, and sends the auxiliary information and the second route to the data processing apparatus.
